(19) United States
(12) Patent Application Publication
(10) Pub. No.: US 2003/0197364 A1
(43) Pub. Date: Oct. 23, 2003

(54) Rain machine

(76) Inventor: Scott H. Winter, Verplanck, NY (US)

Correspondence Address: Scott H. Winter, P.O. Box 99, Verplanck, NY, 10596, US

(21) Appl. No.: 10/126,706

(22) Filed: Apr. 19, 2002

(51) Int. Cl. B60P 3/22

(52) U.S. Cl. 280/838

(57) ABSTRACT

The nature of the technical disclosures of this invention is to point out what is new in the art which my invention pertains, is the process of a man made machine that will cause the atmosphere to become saturated with water vapor and at the same time providing many benefits to the environment such as cooling through evaporation and reflection, reduction of rising ocean water levels that may soon cover our cities, increased amount of rain fall, and safety to our people on our roads and highways, less air pollution, caused by a build up of toxins in the air that are not being washed away by rain fall and less salt being washed into our rivers and oceans caused by man adding salt to our roads and highways and then being washed down storm drains into our rivers and oceans leading to the sea.

### SPECIFICATION

Referring to specific documents which are related to my invention the “Rain Machine” that is a tractor trailer truck with a large holding tank with disbursing apparatus that is connected to the rear of the tank that will spread the ocean or river water. The dispersing apparatus valve opens, allowing the salt water to be released from the tank onto the road or highway and as the truck increases speed, the valves begin to open, allowing the water to be released and as the truck decreases speed the valve or valves begin to close, slowing the flow of water and when the truck comes to a stop, the valve or valves close to stop the flow of water from the trucks tank.

### BACKGROUND OF THE INVENTION

This invention utilizes dirty salt water in exchange for clean, fresh, usable rain water, while providing many other benefits to the environment. In reference to specific documents which are related to specific problems involved in the prior state of technology, which my invention is drawn toward (see introduction) part 1 and part 2 of the Disclosure Document.

### BRIEF SUMMARY OF THE INVENTION

As the substance or general idea of the claimed invention, the tractor trailer truck with a large holding tank containing ocean or river water. Attached to the rear of the tank is a valve to allow the salt water to flow through, to a suitable disbursement apparatus that will release and spread the ocean water over the surface of the road as the truck is in motion. Adding moisture to the environment thus cooling the surface and leaving a light colored, course coating on road, pre-salting and absorbing any petroleum products left on the surface of the road from vehicles. This adds increased traction to the road, later when it snows or rains, the salt will help melt the snow and the rain will wash the salt build up away.

### BRIEF DESCRIPTION OF THE SEVERAL VIEWS OF THE DRAWING

FIG. 1A: Shows a drawing of the tractor trailer truck with a large holding tank containing ocean or river water and connected to the tank, a disbursement apparatus that is releasing ocean or river water onto the road or highway.

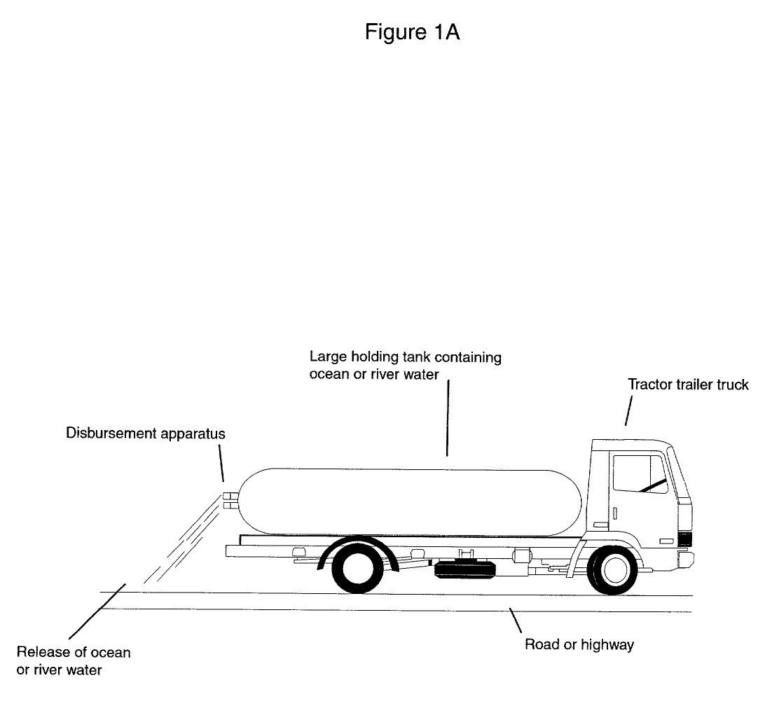

### DETAILED DESCRIPTION OF THE INVENTION

This invention is a tractor trailer truck with a large holding tank made to hold a large amount of ocean or river water. Water that will be pumped from the ocean or river into the tank, through an opening located on the top of the tank. The high speed pump will suck the water out of the ocean or river and put the water into the tank. When the tank is full, the pump will be turned off and the truck driven to a designated road or highway as another truck pulls up to the ocean or river front dock to be refilled with the salty ocean or river water, the high speed pump will again be turned on pumping the salt water from the ocean or river into the top of the tank, filling the tank till the tank is full, when the salt water gets to the top of the tank the pump will be turned off and the truck will be driven to designated road or highway. The valve or valves connected to the tank will open and the disbursement apparatus will spread the salty water onto the road or highway as the truck is in motion covering the road or highway with the water. The valve or valves located at the rear of the tank that open or close may be operated electronically by a signal or manually by a cable from the cab of the truck by the driver, and the disbursement apparatus that spreads the salt water may spin by a electric motor with the valves open, thus spreading the salt water as the truck is in motion, covering the road or highway as the pavement drys the moisture will be released to the atmosphere, adding moisture to the air, that will later fall as rain, also a coarse salt will be left on the road, pre-salting the road, increasing traction making the road safer to drive on, and any petroleum products left on the surface of the road will be absorbed from the salt film and the salt film on the road will help melt any snow that will fall onto the road during winter. In the summer months, the salty water evaporating will add moisture to the air and cause cooling of the road. The salt film will cause reflection of solar heat, thus cooling the environment and at the same time releasing moisture from the surface of the road aiding in making a cold front. With the added moisture from the salt water evaporating into the moist cool air will cause rain to fall.

I claim:

1. A tractor trailer truck with a large holding tank containing ocean or river water and connected to the large holding tank, a disbursement apparatus that is releasing ocean or river water onto the road or highway.
